(19) United States
(12) Patent Application Publication
(10) Pub. No.: US 2026/0066458 A1
(43) Pub. Date: Mar. 5, 2026

(54) Polyolefin-Based Microporous Membrane, Method for Manufacturing the Same, and Secondary Battery Including the Same

(71) Applicant: SK IE Technology Co., Ltd., Seoul (KR)

(72) Inventor: In Hwa JUNG, Daejeon (KR)

(21) Appl. No.: 19/262,331

(22) Filed: Jul. 8, 2025

(30) Foreign Application Priority Data
Aug. 30, 2024 (KR) 10-2024-0117382

(51) Int. Cl. H01M 50/417; H01M 50/406; H01M 50/491

(52) U.S. Cl. CPC H01M 50/417; H01M 50/406; H01M 50/491

(57) ABSTRACT

Provided are a polyolefin-based microporous membrane and methods for manufacturing the same, a separator comprising the polyolefin-based microporous membrane, and a secondary battery comprising the separator. The polyolefin-based microporous membrane or the separator comprising the same comprises a polyolefin, and has a gas permeability of about 2.5×10⁻⁵ Darcy or more, a shrinkage rate in the transverse direction (TD) at 120° C. of about 10% or less, and a BDV index of about 15 or more as represented by the following Equation 1:

$$BDV index = ( \frac{( {P}^{2} + \sqrt[4]{M} )}{D \times \sqrt{d} \times \sqrt{ε}} ) \times 100 \qquad [ Equation 1 ]$$

wherein the variables are defined as follows: P: puncture strength (N/μm) of the polyolefin-based microporous membrane; M: viscosity average molecular weight (×10⁵ g/mol) of polyolefin; D: gas permeability (×10⁻⁵ Darcy) of the polyolefin-based microporous membrane; d: average pore size (nm) of the polyolefin-based microporous membrane; and ε: porosity of the polyolefin-based microporous membrane.)

### CROSS-REFERENCE TO RELATED APPLICATIONS

This application claims priority under 35 U.S.C. § 119 to Korean Patent Application No. 10-2024-0117382, filed on Aug. 30, 2024, in the Korean Intellectual Property Office, the disclosure of which is incorporated herein by reference in its entirety.

### TECHNICAL FIELD

The following disclosure relates to a polyolefin-based microporous membrane, a method for manufacturing the same, and a secondary battery including the same.

### BACKGROUND

In recent years, there is a rapidly growing interest in electrochemical devices used in mobile phones, laptops, electric vehicles, and the like, and their energy storage technology. In particular, research on a separator, which is one of the main constituent elements determining the characteristics of a secondary battery, which is the electrochemical device, is being actively performed. Since the separator is impregnated with an electrolyte and functions as an ion channel, it has a great influence on the physical properties of the secondary battery.

Meanwhile, a polyolefin-based microporous membrane is being used as a separator for a secondary battery in order to have a hole-closing function, which allows ion permeability and provides excellent electrical insulation, cuts off current when an abnormal temperature rise occurs inside a battery, and suppresses excessive temperature rise.

However, when the polyolefin-based microporous membrane is heated to a high temperature of a melting point or higher, it is shrunk and may cause breakage, and thus, research to improve heat resistance is needed.

### SUMMARY

An embodiment of the present disclosure relates to providing a polyolefin-based microporous membrane, a separator comprising the polyolefin-based microporous membrane, and a secondary battery comprising the separator.

Another embodiment of the present disclosure relates to a method for manufacturing the polyolefin-based microporous membrane according to the above embodiment.

In one general aspect, a polyolefin-based microporous membrane includes a polyolefin-based resin, wherein the polyolefin-based microporous membrane has a gas permeability of about 2.5×10⁻⁵ Darcy or more, a shrinkage rate in the transverse direction (TD) at 120° C. of about 10% or less, and a BDV index of 15 or more as represented by the following Equation 1:

$$BDV index = ( \frac{( {P}^{2} + \sqrt[4]{M} )}{D \times \sqrt{d} \times \sqrt{ε}} ) \times 100 \qquad [ Equation 1 ]$$

wherein each variable is defined as follows:
P: puncture strength (N/μm) of the polyolefin-based microporous membrane; M: viscosity average molecular weight (×10⁵ g/mol) of polyolefin;
D: gas permeability (×10⁻⁵ Darcy) of the polyolefin-based microporous membrane;
d: average pore size (nm) of the polyolefin-based microporous membrane; and
ε: porosity of the polyolefin-based microporous membrane.

In an exemplary embodiment, the polyolefin-based resin may have a viscosity average molecular weight (Mv) of about 3×10⁵ g/mol to about 50×10⁵ g/mol.

In an exemplary embodiment, the polyolefin-based microporous membrane may have a break-down voltage (BDV) to average thickness of about 0.13 kV/μm or more, wherein the BDV is measured in accordance with ASTM D149.

In an exemplary embodiment, the polyolefin-based microporous membrane may have a puncture strength of about 0.4 N/μm or more.

In an exemplary embodiment, the porosity of the polyolefin-based microporous membrane may be calculated by the following Equation 2:

$$Porosity = \{ 1 - ( M \times 10000 ) / ( ABT ρ ) \} , \qquad [ Equation 2 ]$$

wherein:
M is mass (in g) of the polyolefin-based microporous membrane after cutting it into a rectangular shape of length A (in cm)×width B (in cm);
T is thickness in μm; and
ρ is density (in g/cm³).

In an exemplary embodiment, the polyolefin-based microporous membrane may have a porosity of about 0.2 or more.

In an exemplary embodiment, the polyolefin-based microporous membrane may have a thickness of about 3 μm to about 20 μm.

In an exemplary embodiment, the polyolefin-based microporous membrane may have an average pore size of about 10 nm to about 100 nm as measured in accordance with ASTM F316-03.

In an exemplary embodiment, the polyolefin-based microporous membrane may have a shrinkage rate in the machine direction (MD) at 120° C. of about 10% or less.

In another general aspect, a method for manufacturing a polyolefin-based microporous membrane includes:
kneading a polyolefin-based resin and a diluent to prepare a molten material;
molding the molten material into a sheet form to form a molded sheet;
stretching the molded sheet; and
extracting the diluent,
wherein the polyolefin-based microporous membrane has a gas permeability of about 2.5×10⁻⁵ Darcy or more, a shrinkage rate in the transverse direction (TD) at about 120° C. of 10% or less, and a BDV index of about 15 represented by Equation 1 as described herein.

In an exemplary embodiment, the stretching of the molded sheet may include stretching the molded sheet in the MD to a length about 6-fold to about 15-fold longer than its original MD length at a temperature of 60° C. to 130° C. to make an MD-stretched molded sheet.

In an exemplary embodiment, the MD-stretched molded sheet in the TD is stretched to a length about 6-fold to about 15-fold longer than its original TD length at a temperature of 80° C. to 130° C.

In an exemplary embodiment, the ratio of length stretched in the MD direction to length stretched in the TD direction (MD/TD) is less than 1.0.

In an exemplary embodiment, the method for manufacturing a polyolefin-based microporous membrane may further include drying after the extracting of the diluent.

In an exemplary embodiment, after the extracting of the diluent, heat fixing at a temperature of about 100° C. to about 150° C. may be further included.

In an exemplary embodiment, the polyolefin-based microporous membrane may be a separator.

In another general aspect, a separator includes a polyolefin-based microporous membrane, wherein the polyolefin-based microporous membrane includes a polyolefin, and has a gas permeability of about 2.5×10⁻⁵ Darcy or more, a shrinkage rate in the TD at 120° C. of about 10% or less, and a BDV index of about 15 or more as represented by Equation 1 as described herein.

In still another general aspect, a secondary battery includes the separator according to the above exemplary embodiment.

Other features and aspects will be apparent from the following detailed description, the drawings, and the claims.

### BRIEF DESCRIPTION OF THE DRAWINGS

FIG. 1 is a schematic plan view of a secondary battery according to an exemplary embodiment.

FIG. 2 is a schematic cross-sectional view of a secondary battery according to an exemplary embodiment.

FIG. 3 is a graph which may confirm a correlation between a BDV index and a BDV (kV/μm) value to average thickness.

### DESCRIPTION OF MAIN ELEMENTS IN THE DRAWINGS

100: Positive electrode
105: Positive electrode current collector
107: Positive electrode lead
110: Positive electrode active material layer
120: Negative electrode active material layer
125: Negative electrode current collector
127: Negative electrode lead
130: Negative electrode
140: Separator
150: Electrode assembly
160: Case

### DETAILED DESCRIPTION OF EMBODIMENTS

Since the embodiments described in the present specification may be modified in many different forms, the technology according to an implementation is not limited to the embodiments set forth herein. Furthermore, throughout the specification, unless otherwise particularly stated, the word “comprising”, “including”, “containing”, “being provided with”, or “having” does not mean the exclusion of any other constituent element, but rather means further inclusion of other constituent elements, and elements, materials, or processes which are not further listed are not excluded.

The numerical range used in the present specification includes all values within the range, including the lower limit and the upper limit, increments logically derived from the form and spanning of a defined range, all double limited values, and all possible combinations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present specification. Unless otherwise defined in the present specification, values which may be outside a numerical range due to experimental error or rounding of a value are also included in the defined numerical range.

Hereinafter, unless otherwise particularly defined in the present specification, “about” may be considered as a value within 30%, 25%, 20%, 15%, 10%, 5%, 3%, 2%, 1%, or 0.5% of a stated value. In certain embodiments, “about” may be within 10% of the stated value.

Hereinafter, the present disclosure will be described in detail (with reference to the accompanying drawings). However, it is only illustrative, and the present disclosure is not limited to the specific embodiments which are illustratively described in the present disclosure.

Polyolefin-based resins with properties well-suited for use in membrane for a separator, e.g., for a secondary battery have been developed and are described herein. Such polyolefin-based resins can be used to manufacture separator membranes with improved performance, which in turn, can be used in a battery, e.g., secondary battery, also with improved performance. The polyolefin-based resin may be prepared with certain materials in certain ratios and processed in a certain manner to impart the improved properties to the membrane, separator, and battery prepared therefrom. Exemplary properties and exemplary methods for manufacturing the polyolefin-based resin, membrane, separator, and battery are described further herein below.

An exemplary embodiment provides a polyolefin-based resin microporous membrane having excellent membrane strength and permeability and simultaneously high insulation properties. In one embodiment, the polyolefin-based microporous membrane comprises a polyolefin-based resin, wherein the polyolefin-based microporous membrane has a gas permeability of about 2.5×10⁻⁵ Darcy or more, a shrinkage rate in the TD at 120° C. of about 10% or less, and a BDV index of about 15 or more, as calculated by the following Equation 1:

$$BDV index = ( \frac{( {P}^{2} + \sqrt[4]{M} )}{D \times \sqrt{d} \times \sqrt{ε}} ) \times 100 \qquad [ Equation 1 ]$$

wherein each variable is defined as follows:
P: puncture strength (N/μm) of the polyolefin-based microporous membrane,
M: viscosity average molecular weight (×10⁵ g/mol) of polyolefin,
D: gas permeability (×10⁻⁵ Darcy) of the polyolefin-based microporous membrane,
d: average pore size (nm) of the polyolefin-based microporous membrane, and
ε: porosity of the polyolefin-based microporous membrane.

In an exemplary embodiment, the gas permeability may be about 2.6×10⁻⁵ Darcy or more, about 2.7×10⁻⁵ Darcy or more, about 2.9×10⁻⁵ Darcy or more, or about 3.0×10⁻⁵ Darcy or more. Although the upper limit of gas permeability is not particularly limited, gas permeability may be, for example, about 5.0×10⁻⁵ Darcy or less, about 4.5×10⁻⁵ Darcy or less, about 4.2×10⁻⁵ Darcy or less, about 4.0×10⁻⁵ Darcy or less, about 3.8×10⁻⁵ Darcy or less, or about 3.5×10⁻⁵ Darcy or less. In an exemplary embodiment, the gas permeability may be measured using a CFP-1500-AEL, a porosity meter available from PMI. Gas permeability can be calculated, for example, as an average value of the Darcy's permeability constant (C) in a range of 100 psi to 200 psi according to Mathematical Formula 2 below:

$$C = ( 8 FTV ) / {π D}^{2} ( {P}^{2} - 1 ) \qquad [ Mathematical Formula 2 ]$$

wherein each variable is defined as follows:
C: Darcy's permeability constant,
F: flow velocity (cc/min),
T: thickness of the polyolefin-based microporous membrane (mm),
V: viscosity of gas (N₂) (0.185 cP),
D: diameter of the polyolefin-based microporous membrane (mm), and
P: pressure (psi).

In an exemplary embodiment, the shrinkage rate in the TD at 120° C. may be about 9.5% or less, about 9% or less, about 8.5% or less, or about 8% or less. Although the lower limit of shrinkage rate is not particularly limited, shrinkage rate may be, for example, about 2% or more, about 3% or more, about 4% or more, or about 4.5% or more. In an exemplary embodiment, the shrinkage rate in the TD may be calculated according to the following Mathematical Equation 4:

$$[ Mathematical Formula 4 ]$$

$$Shrinkage rate = 1 \; 00 \times ( initial interval - interval after leaving at {120}^{∘} C . / initial interval$$

The polyolefin-based microporous membrane may be cut into a size of 15 cm×15 cm, marked at 10 cm intervals in the machine direction (MD) and in the transverse direction (TD), put between A4 papers, and placed in an oven (e.g., Yamato, DKN612) of which the temperature is stabilized to 120° C. The polyolefin-based microporous membrane may be left in the oven for about 1 hour and shrinkage may be measured at regular intervals.

Machine Direction (MD) refers to the direction in which the product is manufactured. It is the axis that aligns with the operating direction of the machine, indicating the primary direction in which the raw material is processed or fabricated.

Transverse Direction (TD) refers to the direction perpendicular to the Machine Direction (MD). It is the horizontal direction of the product, intersecting the machine direction at a right angle.

In an exemplary embodiment, the BDV index may be about 15.2 or more, about 15.3 or more, about 15.5 or more, about 15.6 or more, about 16.0 or more, or about 19.0 or more. Although the upper limit of BDV index is not particularly limited, BDV index may be, for example, about 25.0 or less, about 22.0 or less, about 20.0 or less, or about 19.5 or less.

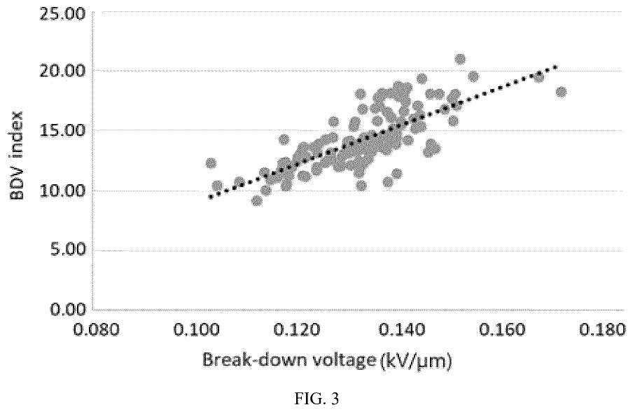

The BDV index defined by Equation 1 is a parameter first provided in the present application and the correlation of BDV index to BDV to average thickness, which will be described further below, has heretofore not been recognized in the art. Specifically, the present inventors confirmed that the BDV index is proportional to a BDV to average thickness (in kV/μm). That is, as the BDV index increases, there is a strong tendency for the BDV to increase. As a result of collecting experimental values using a plurality of polyolefin-based microporous membranes, it was confirmed that when the BDV index is about 15 or more, a BDV to average thickness of about 0.13 kV/μm or more may be achieved (see, e.g., FIG. 3). By employing a polyolefin-based microporous membrane by having a BDV to average thickness of about 0.13 kV/μm and a BDV index of about 15 or more a polyolefin-based microporous membrane having excellent insulation properties may be manufactured.

A polyolefin-based microporous membrane with a BDV index of 15 or more can be manufactured in a variety of manners using a variety of polyolefin materials as will be described further herein below. Optionally, properties of the polyolefin-based microporous membrane may be further enhanced, if desired, by using a polyolefin-based resin with a viscosity average molecular weight (Mv) in a certain range.

In an exemplary embodiment, the polyolefin-based resin may have an My of about 3×10⁵ g/mol to about 50×10⁵ g/mol, about 3×10⁵ g/mol to about 40×10⁵ g/mol, about 3×10⁵ g/mol to about 30×10⁵ g/mol, about 3×10⁵ g/mol to about 20×10⁵ g/mol, about 5×10⁵ g/mol to about 20×10⁵ g/mol, or about 6×10⁵ g/mol to about 20×10⁵ g/mol.

Viscosity average molecular weight of the polyolefin-based resin may be calculated, for example, using the Margolies equation of the following Mathematical Formula 1, after measuring an intrinsic viscosity (η) with a Crystex® model (solvent: trichlorobenzene (TCB) available from Polymer Char):

$$[ Mathematical Formula 1 ]$$

$$Viscosity average molecular weight ( Mv ) = 5.37 \times 1 {0}^{4} \times {[ η ]}^{1.49}$$

While not a strict lower limit, it has been observed that when the viscosity average molecular weight of the polyolefin-based resin is lower than about 3×10⁵ g/mol, the strength of the manufactured polyolefin microporous membrane may be limited, even if the elongation ratio is higher. As a result, it may be difficult to achieve a BDV index of about 15 or more. While not a strict upper limit, when the My of the polyolefin-based resin is higher than about 30×10⁵ g/mol or, in some embodiments, higher than about 50×10⁵ g/mol, difficulty in kneading during extrusion has been observed, and it may be difficult to manufacture a uniform polyolefin-based microporous membrane.

The specific polyolefin material used to manufacture the polyolefin-based resin is not particularly limited. In an exemplary embodiment, the polyolefin-based resin may comprise, for example, polyethylene (or polyethylene-based copolymer) or polypropylene (or polypropylene-based copolymer). In one example, the polyolefin-based resin may comprise a mixture of a polyethylene and a polypropylene having different Mvs. The polyethylene and the polypropylene may comprise a first polyethylene and a first polypropylene, each of which independently have a relatively high molecular weight, and a second polyethylene and a second polypropylene, each of which independently have a relatively low molecular weight. As will be recognized by one of skill in the art, a polyethylene with a high molecular weight may have a molecular weight in the range of about 3 million to 10 million g/mol. A polypropylene with a high molecular weight may have a molecular weight in the range of about 10,000 g/mol to about 40,000 g/mol. A polyethylene with a low molecular weight may have a molecular weight in the range of about 1,000 g/mol to about 50,0000 g/mol. A polypropylene with a low molecular weight may have a molecular weight in the range of about 1,000 g/mol to about 10,000 g/mol.

When the polyolefin-based resin comprises both a polyethylene and a polypropylene, the weight ratio of polyethylene to polypropylene may be, for example, about 10:90 to about 90:10, about 30:70 to about 70:30, about 40:60 to about 60:40, about 30:70 to about 40:60, or about 60:40 to about 70:30. In other embodiments, polyethylene may be used alone as the polyolefin-based resin.

The melting temperature of the polyolefin-based resin (comprising polyethylene, polypropylene, or a mixture thereof) is not particularly limited, but may be, for example, about 100° C. to about 180° C., about 110° C. to about 180° C., about 100° C. to about 150° C., about 110° C. to about 140° C., about 120° C. to about 140° C., about 120° C. to about 135° C., about 120° C. to about 180° C., about 130° C. to about 180° C., about 130° C. to about 170° C., about 140° C. to about 170° C., or about 145° C. to about 165° C.

In an exemplary embodiment, the polyolefin-based microporous membrane may have a BDV to average thickness of about 0.13 kV/μm or more, about 0.135 kV/μm or more, about 0.14 kV/μm or more, or about 0.15 kV/μm or more. Although the upper limit of BVD to average thickness is not particularly limited, for example, BDV to average thickness may be about 0.3 kV/μm or less, about 0.25 kV/μm or less, about 0.2 kV/μm or less, about 0.18 kV/μm or less, about 0.17 kV/μm or less, or about 0.16 kV/μm or less.

BDV to average thickness may be measured in accordance with ASTM D149. Specifically BDV may be calculated by placing a microporous membrane between electrodes of a withstand voltage tester (Croma, 19052 model) under a dry room (dew point temperature: −60° C.), measuring a voltage (kV) when a leakage current value measured under the conditions of increasing an applied voltage to 5 kV/10 sec is 5 mA, and dividing the voltage by an average thickness. Average thickness may be obtained by overlapping the microporous membrane in 8 layers, measuring each thickness at 5 random points in the TD direction by a thickness meter (e.g., such as one available from Mitutoyo), dividing the value by 5 to derive an average thickness of the 8-layer polyolefin-based microporous membrane, and dividing the value by 8 again to derive an average thickness of a single polyolefin-based microporous membrane.

In an exemplary embodiment, the polyolefin-based microporous membrane may have a puncture strength of about 0.4 N/μm or more, about 0.45 N/μm or more, about 0.5 N/μm or more, about 0.53 N/μm or more, about 0.54 N/μm or more, or about 0.55 N/μm or more. Although the upper limit for puncture strength is not particularly limited, the puncture strength may be, for example, about 1.0 N/μm or less, about 0.8 N/μm or less, about 0.7 N/μm or less, about 0.65 N/μm or less, or about 0.6 N/μm or less.

Puncture strength may be measured, for example, with Universal Test Machine (UTM) 3345 available from INSTRON, at a speed of 120 mm/min using a pin tip having a diameter of 1.0 mm and a radius of curvature of 0.5 mm.

Porosity of the polyolefin-based microporous membrane may be calculated by the following Equation 2:

$$Porosity = \{ 1 - ( M \times 10000 ) / ( ABT ρ ) \} \qquad [ Equation 2 ]$$

wherein:
M is mass (in g) of the polyolefin-based microporous membrane after cutting it into a rectangular shape of length A (in cm)×width B (in cm);
T is thickness in μm; and
ρ is density (in g/cm³).

In exemplary embodiments, the porosity of the polyolefin-based resin may be, for example, about 0.2 or more, about 0.25 or more, about 0.3 or more, about 0.35 or more, or about 0.4 or more. Although the upper limit of porosity is not particularly limited, the porosity may be, for example, about 0.7 or less, about 0.6 or less, about 0.5 or less, or about 0.45 or less.

In an exemplary embodiment, the polyolefin-based microporous membrane may have a thickness of, for example, about 3 μm to about 20 μm, about 3 μm to about 15 μm, about 5 μm to about 15 μm, or about 6 μm to about 12 μm. Thickness may be measured, for example, using a TESA Micro-Hite Electronic Gauge (available from TESA), which is a contact type thickness gauge with a precision degree of 0.1 μm, under measurement pressure conditions of 0.63 N.

By implementing a gas permeability, shrinkage rate in the transverse direction at 120° C., and BDV index of the polyolefin-based microporous membrane as disclosed herein, a polyolefin-based microporous membrane may display high strength and thermal safety even at a small thickness.

In an exemplary embodiment, the polyolefin-based microporous membrane may have an average pore size of about 10 nm to about 100 nm, about 10 nm to about 80 nm, about 20 nm to about 80 nm, about 20 nm to about 60 nm, about 30 nm to about 50 nm, or about 35 nm to about 45 nm. Average pore size may be measured, for example, using a CFP-1500-AEL (available from PMI), which is a porosimeter in accordance with ASTM F316-03. Specifically, average pore size may be measured by a half dry method using a Galwick solution (surface tension: 15.9 dyne/cm) provided by PMI. Properties of the polyolefin-based microporous membrane may be further improved by processing the polyolefin-based resin in a certain manner. As such, provided herein are exemplary methods for manufacturing a polyolefin-based microporous membrane from a polyolefin-based resin. In one embodiment, such a method may comprise the following steps:
kneading a polyolefin-based resin and a diluent to prepare a molten material;
molding the molten material into a sheet form to form a molded sheet;
stretching the molded sheet; and
extracting the diluent to make a polyolefin-based microporous membrane.

Such a method may produce a polyolefin-based microporous membrane having a gas permeability of about 2.5×10⁻⁵ Darcy or more, a shrinkage rate in the TD at 120° C. of about 10% or less, and a BDV index of about 15 or more.

The above description regarding the various properties of the polyolefin-based microporous membrane may be applied identically to polyolefin-based microporous membranes prepared according to the aforementioned method as well as any method described herein below; accordingly, redundant description is omitted.

In an exemplary embodiment, the weight ratio of polyolefin-based resin and diluent may be, for example, about 5:95 to about 50:50, about 10:90 to about 50:50, about 10:90 to about 40:60, about 10:90 to about 35:65, or about 15:85 to about 40:60.

In an exemplary embodiment, the molded sheet may be stretched in the MD to a length about 6-fold to about 15-fold longer than its original MD length, for example, to a length about 6-fold to about 13-fold, about 6-fold to about 12-fold, about 6-fold to about 10-fold, about 7-fold to about 12-fold, about 7-fold to about 10-fold, about 8-fold to about 12-fold, or about 8-fold to about 10-fold longer than its original MD length to make an MD-stretched molded sheet. Stretching may be performed at a temperature of about 60° C. to about 130° C., such as about 60° C. to about 120° C., about 60° C. to about 110° C., about 60° C. to about 100° C., about 60° C. to about 95° C., about 60° C. to about 90° C., about 70° C. to about 100° C., about 70° C. to about 95° C., about 80° C. to about 100° C., or about 80° C. to about 95° C.

In an exemplary embodiment, although the stretching temperature in the MD is not necessarily limited, the stretching temperature may be set to a temperature about 30° C. or more lower than the melting temperature of the molded sheet. In certain embodiments, it has been observed that when using a temperature within about 30° C. of the melting temperature of the molded sheet, the shrinkage rate of the manufactured polyolefin-based microporous membrane is typically about 10% or less, which makes it difficult to simultaneously achieve a gas permeability of about 2.5×10⁻⁵ Darcy or more.

The melting temperature of the molded sheet may be determined using a differential scanning calorimetry (DSC) as the peak position in a DSC curve. DSC scanning may be performed at a temperature range from about 25° C. to about 200° C. at a heating rate of 10° C./min under a nitrogen atmosphere, using, e.g., a Thermal Analysis System DSC 3+model, which is a differential scanning calorimeter available from Mettler Toledo. For example, 5 mg of sample may be tested, and the melting temperature may be defined as the peak temperature on the curve. Although the melting temperature of the molded sheet is not particularly limited, the melting point of the molded sheet may be, for example, about 100° C. to about 150° C., about 120° C. to about 140° C., about 120° C. to about 130° C., or about 120° C.

In an exemplary embodiment, the MD-stretched molded sheet may further be stretched in the TD to a length about 6-fold to about 15-fold longer than its TD length after the stretching in the MD, for example, to a length about 7-fold to about 15-fold, about 7-fold to about 13-fold, about 8-fold to about 12-fold, or about 9-fold to about 11-fold longer than its TD length, to make a MD/TD stretched molded sheet. Stretching in the TD may be performed at a temperature of about 80° C. to about 130° C., such as about 80° C. to about 130° C., about 90° C. to about 130° C., about 90° C. to about 120° C., or about 100° C. to about 120° C.

In an exemplary embodiment, further stretching the stretched molded sheet in the TD may comprise two or three further stretching sessions, such a pre-heating (PH) session, a further stretching (ST) session, and a heat-setting (HS) session in order. The PH session may comprise applying heat to the MD/TD stretched molded sheet (without stretching). The ST session may comprise stretching the pre-heated MD/TD stretched molded sheet in the TD by applying heat to the sheet. The HS session may comprise applying heat to the stretched molded sheet without stretching/relaxation.

The temperature during the ST session may be equal to or lower than the melting temperature of the stretched molded sheet (e.g., after stretching the molded sheet in the MD). The temperature during the PH session may be lower than the temperature of the ST session, and may be, for example, about 1° C. to about 5° C. lower, about 1° C. to about 3° C. lower, or about 2° C. lower. The temperature during the HS session may be higher than the temperature of the ST session, and may be, for example, about 1° C. to about 5° C. higher, about 2° C. to about 4° C. higher, or about 3° C. higher. By using the aforementioned temperatures, the pore size of the manufactured polyolefin microporous membrane may be advantageously reduced. For example, the temperature of the PH session may be set to a range of about 110° C. to about 130° C., about 110° C. to about 125° C., or about 115° C. to about 125° C., the temperature of the ST session may be set to a range of about 115° C. to about 135° C., about 115° C. to 130° C., or about 120° C. to about 130° C., and the temperature of the HS session may be set to a range of about 120° C. to about 140° C., about 120° C. to about 135° C., or about 120° C. to about 130° C.

In an exemplary embodiment, the ratio of length stretched in the MD direction to length stretched in the TD direction (MD/TD) may be about 1.0 or less, about 0.95 or less, about 0.9 or less, or about 0.89 or less. Although the lower limit of stretching ratio is not limited, the stretching ratio may be, for example, about 0.5 or more, about 0.6 or more, about 0.7 or more, about 0.8 or more, or about 0.82 or more. In certain instances, it has been observed that when the stretching ratio exceeds about 1.0, it may be difficult to achieve a shrinkage rate of 10% or less in the manufactured polyolefin microporous membrane.

The preparing of a molten material may comprise, for example, melting and kneading a polyolefin-based resin and a diluent through an extruder to generate a molten material that is a thermodynamically single phase.

The type of diluent combined with the polyolefin-based resin is not particularly limited and may be any organic compound that forms a single phase with the polyolefin-based resin (or a mixture of the polyolefin-based resin and other types of resins) during extrusion. A non-limiting example of the diluent may include, for example, aliphatic or cyclic hydrocarbons such as liquid paraffin including nonane, decane, decaline, and liquid paraffin (or paraffin oil), and paraffin wax; phthalate ester such as dibutyl phthalate and dioctyl phthalate; fatty acids having 10 to 20 carbon atoms such as palmitic acid, stearic acid, oleic acid, linoleic acid, and linolenic acid; fatty acid alcohols having 10 to 20 carbon atoms such as palmitic alcohol, stearic alcohol, and oleic alcohol; and the like. These may be used alone or in combination of two or more. In certain embodiments, liquid paraffin, which is an example of a low-molecular weight organic material having a similar molecular structure to polyolefin, may be used.

In an exemplary embodiment, a drying step may be further included after extracting the diluent.

In an exemplary embodiment, after extracting the diluent or drying, a heat treatment step may be further included. The heat treatment step may include stretching, heat fixation, and/or relaxation steps. The temperature of the heat treatment or heat fixation step may be set to a temperature lower than the melting temperature of the extracted and/or dried membrane, for example, lower by about 3° C. to about 20° C., or lower by about 5° C. to about 10° C. In an exemplary embodiment, the heat treatment step or the heat fixation step may be performed at a temperature of about 100° C. to about 150° C., for example, at a temperature of about 110° C. to about 150° C., about 120° C. to about 150° C., or about 130° C. to about 140° C. When the temperature is higher than the above-specified ranges, it may be difficult to achieve a gas permeability of about 2.5×10⁻⁵ Darcy or more. When the temperature is lower than the above-specified ranges, it may be difficult to achieve a shrinkage rate of about 10% or less.

In exemplary embodiments when the heat treatment step includes a stretching step, the membrane may be stretched to a length about 1.3-fold to about 3-fold, about 1.3-fold to about 2-fold, or about 1.5-fold to about 2-fold longer than its original length. Stretching to shorter or longer lengths may result in difficulty in achieving a gas permeability of about 2.5×10⁻⁵ Darcy or more. In exemplary embodiments when the heat treatment step includes a relaxation step, the membrane may be allowed to relax to about 0.5-fold to about 0.95-fold, about 0.7-fold to about 0.95-fold, about 0.8-fold to about 0.95-fold, or about 0.8-fold to about 0.9-fold of its stretched length. Relaxing the stretched sheet to lengths outside these ranges may result in difficulty achieving a shrinkage rate in the TD at 120° C. of about 10% or less.

A polyolefin-based microporous membrane prepared with properties as described herein and/or prepared by methods described herein may be used as a separator, and specifically, may be a separator for a secondary battery. Accordingly, provided herein is a separator comprising a polyolefin-based microporous membrane, wherein the polyolefin-based microporous membrane comprises at least one polyolefin, and has a gas permeability of about 2.5×10⁻⁵ Darcy or more, a shrinkage rate of about 10% or less, and a BDV index represented of about 15 or more.

A separator having excellent insulation properties may be manufactured by employing a polyolefin-based porous membrane displaying the desired gas permeability, shrinkage rate in the TD, and BDV index and simultaneously prevent side reactions due to an electrode volume change inside a battery and/or formation of dendrite in a negative electrode, even when the battery is repeatedly charged and discharged. In addition, since the separator has a high BDV, local damage of the separator may be effectively prevented, even when overvoltage is applied from the outside such as during overcharging. Thus, current leakage resulting from a damaged separator may be suppressed.

Another example embodiment provides a secondary battery comprising a separator comprising a polyolefin-based porous membrane as described herein.

A secondary battery may include the separator comprising a polyolefin-based porous membrane as described herein, a positive electrode; a negative electrode opposite to the positive electrode; and an electrolyte solution.

In an exemplary embodiment, the secondary battery may have an initial resistance of about 54 mΩ or less or about 53 mΩ or less, and although the lower limit of initial resistance is not particularly limited, initial resistance may be, for example, about 30 mΩ or more, about 35 mΩ or more, about 40 mΩ or more, or about 50 mΩ or more. In an exemplary embodiment, the thickness-normalized initial electrical resistance of the secondary battery may be about 6.6 mf/μm or less.

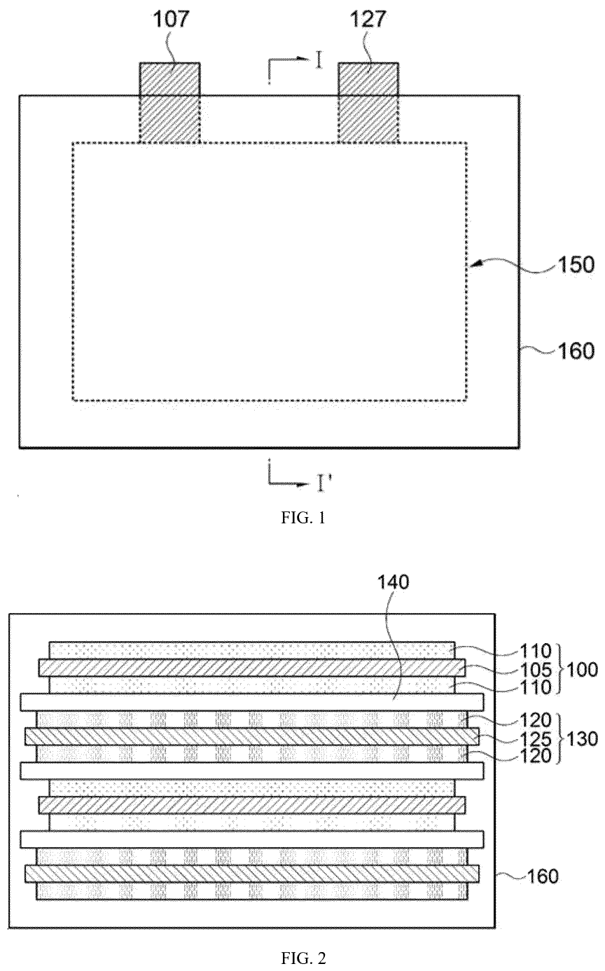

FIGS. 1 and 2 are schematic plan view and cross-sectional view showing a secondary batteries according to exemplary embodiments, respectively. FIG. 2 is a cross-sectional view taken along the line I-I′ of FIG. 1.

In FIGS. 1 and 2, the secondary battery may include a positive electrode 100 and a negative electrode 130 opposite to the positive electrode 100.

The positive electrode 100 may include a positive electrode current collector 105 and a positive electrode active material layer 110 on the positive electrode current collector 105.

The positive electrode active material layer 110 may include a positive electrode active material, and, if necessary, a positive electrode binder and a conductive material.

The positive electrode 100 may be manufactured by, for example, mixing a positive electrode active material, a positive electrode binder, a conductive material, a dispersion medium, and the like; stirring to prepare a positive electrode slurry; applying the slurry on the positive electrode current collector 105; drying; and rolling. The positive electrode current collector 105 may include, for example, stainless steel, nickel, aluminum, titanium, copper, or an alloy thereof, and more preferably, may include aluminum or an aluminum alloy.

In an exemplary embodiment, the secondary battery may be a lithium secondary battery, and may be, for example, a lithium metal secondary battery, a lithium ion secondary battery, a lithium polymer secondary battery, a lithium ion polymer secondary battery, or the like.

Hereinafter, the secondary battery according to an exemplary embodiment will be schematically described.

### [Positive Electrode]

A positive electrode may include a positive electrode current collector, and a positive electrode mixture layer placed on at least one surface of the positive electrode current collector.

### (Positive Electrode Current Collector)

The positive electrode current collector may include stainless steel, nickel, aluminum, titanium, or an alloy thereof. The positive electrode current collector may also include carbon, nickel, titanium, aluminum, which is surface-treated with silver, or stainless steel. Although the thickness of the positive electrode current collector is not limited, the positive electrode current collector may have a thickness of, for example, about 10 μm to about 50 μm.

### (Positive Electrode Material)

The positive electrode mixture layer may include a positive electrode active material. The positive electrode active material may include a compound that may reversibly intercalate and deintercalate lithium ions.

According to exemplary embodiments, the positive electrode active material may include a lithium-nickel metal oxide. The lithium-nickel metal oxide may further include at least one of cobalt (Co), manganese (Mn), and aluminum (Al).

In some exemplary embodiments, the positive electrode active material or the lithium-nickel metal oxide may include a layered structure, or a crystal structure represented by the following Chemical Formula 1:

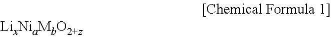

wherein 0.9≤x≤1.2, 0.6≤a≤0.99, 0.01≤b≤0.4, and −0.5≤z≤0.1. As described above, M may include Co, Mn, and/or Al.

The chemical structure represented by Chemical Formula 1 shows a bonding relationship included in the layered structure or the crystal structure of the positive electrode active material, but does not imply that other additional elements are excluded. For example, M includes Co and/or Mn, and Co and/or Mn may be provided as a main active element of the positive electrode active material with Ni. Chemical Formula 1 is provided to express the bonding relationship of the main active elements and should be understood as a formula covering introduction of an additional element and substitution.

In an exemplary embodiment, auxiliary elements that are added to the main active elements to enhance chemical stability of the positive electrode active material or the layered structure/crystal structure may be further included. The auxiliary element(s) may be incorporated into the layered structure/crystal structure and form a bond, and in this case also, should be understood to be included in the range of the chemical structure represented by Chemical Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. The auxiliary element may act as, for example, an auxiliary active element which contributes to the capacity/output activity of the positive electrode active material with Co or Mn, like Al.

For example, the positive electrode active material or the lithium-nickel metal oxide may include a layered structure or a crystal structure represented by the following Chemical Formula 1-1:

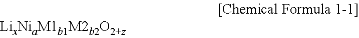

wherein M1 includes Co, Mn, and/or Al, M2 includes the auxiliary elements described above, and 0.9≤x≤1.2, 0.6≤a≤0.99, 0.01≤b1+b2≤0.4, and −0.5≤z≤0.1.

The positive electrode active material may further include a coating element or a doping element. For example, elements which are substantially identical or similar to the auxiliary elements described above may be used as a coating element or a doping element. For example, among the elements described above, a single element or a combination of two or more elements may be used as a coating element or a doping element.

The coating element or the doping element may be present on the surface of the lithium-nickel metal oxide particles or may be penetrated through the surface of the lithium-nickel metal composite oxide particles and included in the combined structure represented by Chemical Formula 1 or Chemical Formula 1-1.

The positive electrode active material may include a nickel-cobalt-manganese (NCM)-based lithium oxide. In this case, an NCM-based lithium oxide having an increased nickel content may be used.

Ni may be provided as a transition metal related to the output and the capacity of a lithium secondary battery. Therefore, as described above, since a high-content (high-Ni) composition is adopted into the positive electrode active material, a high-capacity positive electrode and a high-capacity lithium secondary battery may be provided.

However, as the content of Ni increases, the long-term preservation stability and the life stability of the positive electrode or the secondary battery may be relatively reduced, and a side reaction with an electrolyte may be increased. However, according to exemplary embodiments, the life stability and the capacity retention properties may be improved by Mn while maintaining the electrical conductivity by including Co.

The content of Ni in the NCM-based lithium oxide (for example, the mole fraction of nickel of the total moles of nickel, cobalt, and manganese) may be about 0.6 or more, about 0.7 or more, or about 0.8 or more. In some exemplary embodiments, the mole fraction content of Ni may be about 0.8 to about 0.95, about 0.82 to about 0.95, about 0.83 to about 0.95, about 0.84 to about 0.95, about 0.85 to about 0.95, or about 0.88 to about 0.95.

In some exemplary embodiments, the positive electrode active material may include a lithium cobalt oxide-based active material, a lithium manganese oxide-based active material, a lithium nickel oxide-based active material, or a lithium iron phosphate (LFP)-based active material (for example, LiFePO₄).

In some exemplary embodiments, the positive electrode active material may include a Mn-rich-based active material having a chemical structure or crystal structure represented by Chemical Formula 2, a Li-rich layered oxide (LLO)/over lithiated oxide (OLO)-based active material, or a Co-less-based active material:

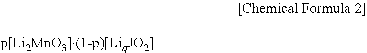

wherein 0<p<1, 0.9≤q≤1.2, and J includes at least one element of Mn, Ni, Co, Fe, Cr, V, Cu, Zn, Ti, Al, Mg, and B.

### (Method for Manufacturing Positive Electrode)

The positive electrode active material may be mixed into the solvent to prepare a positive electrode slurry. After coating the positive electrode current collector with the positive electrode slurry, drying and rolling may be performed to manufacture a positive electrode mixture layer. The coating process may be performed by a method such as gravure coating, slot die coating, multilayer simultaneous die coating, imprinting, doctor blade coating, dip coating, bar coating, and casting, but is not limited thereto. The positive electrode mixture layer may further include a binder, and may optionally further include a conductive material, a thickener, and the like. Herein, the binder and the conductive material are as described above.

### (Positive Electrode Solvent)

A non-limiting example of the solvent used in the preparation of the positive electrode mixture may include N-methyl-2-pyrrolidone (NMP), dimethyl formamide, dimethyl acetamide, N,N-dimethylaminopropylamine, ethylene oxide, tetrahydrofuran, isobutyl butyrate, butyl butyrate, xylene, anisole, and the like.

(Positive Electrode Binder)

The binder may include a non-water-based binder and/or a water-based binder, or rubber-based binder and/or fluorine-based binder, and may include, for example, polyvinylidene fluoride (PVDF), poly(vinylidene fluoride-co-hexafluoropropylene (PVDF-HFP), polyacrylonitrile, polymethylmethacrylate, acrylonitrile butadiene rubber (NBR), polybutadiene rubber (BR), styrene-butadiene rubber (SBR), and the like. In an exemplary embodiment, a PVDF-based binder may be used as a positive electrode binder.

### (Positive Electrode Conductive Material)

The conductive material may be added for increasing conductivity of the positive electrode mixture layer and/or mobility of lithium ions or electrons. For example, the conductive material may be a linear conductive material and/or a dot-shaped conductive material, and may include, for example, carbon-based conductive materials such as graphite, carbon black, acetylene black, ketjen black, graphene, carbon nanotubes, vapor-grown carbon fiber (VGCF), carbon fiber, and carbon nanofiber, and/or metal-based conductive materials including tin, tin oxide, titanium oxide, perovskite materials such as LaSrCoO₃ and LaSrMnO₃, and the like, but is not limited thereto.

### (Positive Electrode Thickener/Dispersant)

If necessary, the positive electrode mixture may further include a thickener and/or a dispersant and the like. As an exemplary embodiment, the positive electrode mixture may include a thickener such as carboxymethyl cellulose (CMC).

### [Negative Electrode]

The negative electrode may include a negative electrode current collector and a negative electrode mixture layer placed on at least one surface of the negative electrode current collector.

### (Negative Electrode Current Collector)

Anon-limiting example of the negative electrode current collector may include a copper foil, a nickel foil, a stainless-steel foil, a titanium foil, a nickel foam, a copper foam, a polymer substrate coated with a conductive metal, and the like. The thickness of the negative electrode current collector is not limited, but may be, for example, about 10 μm to about 50 μm.

### (Negative Electrode Material)

The negative electrode mixture layer may include a negative electrode active material. As the negative electrode active material, a material capable of adsorbing or desorbing lithium ions may be used. For example, the negative electrode active material may be a carbonaceous material such as crystalline carbon, amorphous carbon, carbon composite, and carbon fiber; lithium metal; lithium alloy; a silicon (Si)-containing material, a tin (Sn)-containing material, or the like.

The amorphous carbon may include, for example, hard carbon, soft carbon, coke, mesocarbon microbead (MCMB), mesophase pitch-based carbon fiber (MPCF), and the like.

The crystalline carbon may include, for example, graphite-based carbon such as natural graphite, artificial graphite, graphitized coke, graphitized MCMB, and graphitized MPCF.

The lithium metal may include a pure lithium metal or a lithium metal on which a protective layer for suppressing dendrite growth and the like is formed. In an exemplary embodiment, a lithium metal-containing layer which is deposited or coated on a negative electrode current collector may be used as a negative electrode active material. In an exemplary embodiment, a lithium thin film layer may be used as a negative electrode active material layer.

Elements that may be included in the lithium alloy may include aluminum, zinc, bismuth, cadmium, antimony, silicon, lead, tin, gallium, indium, or the like.

The silicon-containing material may impart increased capacity. The silicon-containing material may include Si, SiOₓ (0<x<2), metal-doped SiOₓ (0<x<2), a silicon-carbon composite, and the like. The metal may include lithium and/or magnesium, and the metal-doped SiOₓ (0<x<2) may include metal silicate.

### (Method for Manufacturing Negative Electrode)

The negative electrode active material may be mixed into the solvent to prepare a negative electrode slurry. After coating/depositing the negative electrode current collector with the negative electrode slurry, drying and rolling may be performed to manufacture a negative electrode mixture layer. The coating process may be performed by a method such as gravure coating, slot die coating, multilayer simultaneous die coating, imprinting, doctor blade coating, dip coating, bar coating, and casting, but is not limited thereto. The negative electrode mixture layer may further include a binder, and may optionally further include a conductive material, a thickener, and the like.

In some exemplary embodiments, the negative electrode may include a negative electrode active material layer in a lithium metal form formed by a deposition/coating process.

### (Negative Electrode Solvent)

A non-limiting example of the solvent for a negative electrode mixture may include water, pure water, deionized water, distilled water, ethanol, isopropanol, methanol, acetone, n-propanol, t-butanol, isobutyl isobutyrate, butyl butyrate, xylene, anisole, and the like.

### (Negative Electrode Binder/Conductive Material/Thickener)

A binder, the conductive material, and the thickener together with the materials described above may be used in the manufacture of a positive electrode.

In some exemplary embodiments, rubber-based binder such as a styrene-butadiene rubber (SBR)-based binder, carboxymethyl cellulose (CMC), a polyacrylic acid-based binder, a poly(3,4-ethylenedioxythiophene) (PEDOT)-based binder, and the like may be used as a negative electrode binder.

### [Electrode Assembly]

According to exemplary embodiments, the positive electrode, the negative electrode, and the separator may be repeatedly disposed to form an electrode assembly. In some exemplary embodiments, the electrode assembly may be a winding type, a stacking type, a zigzag (z)-folding type, or a stack-folding type.

### [Electrolyte Solution]

A lithium secondary battery may be defined by housing the electrode assembly in a case with an electrolyte. According to exemplary embodiments, a nonaqueous electrolyte solution may be used as the electrolyte.

### (Lithium Salt/Organic Solvent)

A nonaqueous electrolyte solution includes a lithium salt as an electrolyte and an organic solvent, the lithium salt is represented by, for example, Li⁺X⁻, and an example of an anion (X⁻) of the lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, and the like.

The organic solvent should have sufficient solubility of the lithium salt or the additive and may include an organic compound that is nonreactive in a battery setting. The organic solvent may include, for example, at least one of carbonate-based solvents, ester-based solvents, ether-based solvents, ketone-based solvents, alcohol-based solvents, and aprotic solvents. An example of the organic solvent may include propylene carbonate (PC), ethylene carbonate (EC), butylene carbonate, diethyl carbonate (DEC), dimethyl carbonate (DMC), ethyl methyl carbonate (EMC), methyl propyl carbonate, ethyl propyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF) and 2-methyltetrahydrofuran, ethyl alcohol, isopropyl alcohol, dimethylsulfoxide, acetonitrile, sulfolane, gamma-butyrolactone, propylene sulfite, and the like. These may be used alone or in combination of two or more.

### (Additive)

The nonaqueous electrolyte solution may further include an additive. The additive may include, for example, cyclic carbonate-based compounds, fluorine-substituted carbonate-based compounds, sultone-based compounds, cyclic sulfate-based compounds, cyclic sulfite-based compounds, phosphate-based compounds, and borate-based compounds.

The cyclic carbonate-based compound may include vinylene carbonate (VC), vinylethylene carbonate (VEC), or the like.

The fluorine-substituted carbonate-based compound may include fluoroethylene carbonate (FEC) and the like.

The sultone-based compound may include 1,3-propane sultone, 1,3-propene sultone, 1,4-butane sultone, and the like.

The cyclic sulfate-based compound may include 1,2-ethylene sulfate, 1,2-propylene sulfate, and the like.

The cyclic sulfite-based compound may include ethylene sulfite, butylene sulfite, and the like.

The phosphate-based compound may include lithium difluoro bis-oxalato phosphate, lithium difluoro phosphate, and the like.

The borate-based compound may include lithium bis(oxalate) borate and the like.

### [Solid Electrolyte]

In some exemplary embodiment, a solid electrolyte may be used instead of the nonaqueous electrolyte solution described above. In this case, the lithium secondary battery may be manufactured in an all-solid-state battery form. In addition, a solid electrolyte layer may be placed between the positive electrode and the negative electrode, instead of the separator described above.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li_{2O}, Li₂S—P₂S₅—Li_{2O}—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and Z is Ge, Zn, or Ga), Li₂S—GeS₂, Li₂S—SiS₂—Li₃PO₄, Li₂S—SiS₂—LiₚMO_{q}, (p and q are positive numbers, and M is P, Si, Ge, B, Al, Ga, or In), Li₇₋ₓPS₆₋ₓClₓ (0≤x≤2), Li₇₋ₓ PS₆₋ₓBrₓ (0≤x≤2), Li₇₋ₓPS₆₋ₓIₓ (0≤x≤2), and the like. These may be used alone or in combination of two or more.

In an exemplary embodiment, the solid electrolyte may include, for example, an oxide-based amorphous solid electrolyte such as Li_{2O}—B₂O₃—P₂O₅, Li_{2O}—SiO₂, Li_{2O}—B₂O₃, and Li_{2O}—B₂O₃—ZnO.

### [Cell Structure]

For example, electrode tabs (positive electrode tab and negative electrode tab) may protrude from the positive electrode current collector and the negative electrode current collector and extend to one side of a case, respectively. The electrode tabs may be connected to electrode leads (positive electrode lead and negative electrode lead) which are fused with the one side of the case and extended or exposed to the outside of the case. For example, a pouch-type case, an angular case, a cylindrical case, a coin-type case, and the like may be used.

Hereinafter, the examples will be further described with reference to the specific experimental examples. It is apparent to those skilled in the art that the examples and the comparative examples included in the experimental examples only illustrate an exemplary embodiment and do not limit the appended claims, and various modifications and alterations of the examples may be made within the range of the scope and spirit of the present disclosure, and these modifications and alterations will fall within the appended claims.

### Test Method

1. Viscosity Average Molecular Weight (Mv, g/Mol)

The viscosity average molecular weight of a polyolefin was obtained by measuring intrinsic viscosity (η) with a Crystex® model available from Polymer Char (solvent: trichlocobenzene (TCB)) and then performing calculation of the following Margolies equation:

$$[ Mathematical Formula 1 ]$$

$$Viscosity average molecular weight ( Mv ) = 5.37 \times 1 {0}^{4} \times {[ η ]}^{1.49}$$

### 2. Thickness (μm)

The thickness of the microporous membrane was measured using a Micro-Hite Electronic Gauge available from TESA, which is a contact type thickness gauge with a precision degree of 0.1 μm, at a measurement pressure of 0.63 N.

### 3. Puncture Strength (N/μm)

The puncture strength of the microporous membrane was measured using a Universal Test Machine (UTM) 3345 available from INSTRON, at a speed of 120 mm/min and a pin tip having a diameter of 1.0 mm and a radius of curvature of 0.5 mm.

### 4. Gas Permeability (×10⁻⁵ Darcy)

The gas permeability of the microporous membrane was measured using a CFP-1500-AEL porosimeter available from PMI. Gas permeability was calculated using the following Darcy's permeability constant (C), as an average value of the Darcy's permeability constant in a range of 100 psi to 200 psi:

$$C = ( 8 FTV ) / π {D}^{2} ( {P}^{2} - 1 ) \qquad [ Mathematical Formula 2 ]$$

wherein each variable is defined as follows:
C: Darcy's permeability constant,
F: flow velocity (cc/min),
T: thickness of the polyolefin-based microporous membrane (mm),
V: viscosity of gas (N₂) (0.185 cP),
D: diameter of the polyolefin-based microporous membrane (mm), and
P: pressure (psi).

### 5. Porosity

The porosity of the microporous membrane was determined by calculating the space inside the microporous membrane. Specifically, the porosity was calculated by the following Equation 2, using mass (M, g) measured after cutting a microporous membrane sample into a rectangular shape of A cm×B cm (thickness: T, μm), and density (ρ, g/cm³) of polyolefin: T, μm):

$$Porosity = \{ 1 - ( M \times 10000 ) / ( ABT ρ ) \} \qquad [ Equation 2 ]$$

### 6. Average Pore Size (Nm)

The average pore size of the microporous membrane was measured using a CFP-1500-AEL porosimeter available from PMI in accordance with ASTM F316-03. The measurement was performed through a half dry method, and a Galwick solution provided by PMI (surface tension: 15.9 dyne/cm) was used.

### 7. Shrinkage Rates in MD and TD (MD/TD, %) at 120° C. For 1 Hour

The shrinkage rates in the TD and in the MD were calculated according to the following Mathematical Formula 4, by cutting the microporous membrane into a size of 15 cm×15 cm, marking the membrane at each 10 cm point in the MD and in the TD, putting the membrane between papers, placing the membrane in an oven (Yamato, DKN612) of which the temperature was stabilized to 120° C., leaving the membrane for 1 hour, and measuring a change in intervals (initial interval: 10 cm):

$$[ Mathematical Formula 4 ]$$

$$Shrinkage rate = 100 \times ( initial interval - interval after leaving at 120 ° C . ) / initial interval$$

### 8. BDV Index

The BDV index was calculated by the following Equation 1:

$$BDV index = ( \frac{( {P}^{2} + \sqrt[4]{M} )}{D \times \sqrt{d} \times \sqrt{ε}} ) \times 100 \qquad [ Equation 1 ]$$

wherein each variable is defined as follows:
P: puncture strength (N/μm) of the microporous membrane,
M: viscosity average molecular weight (×10⁵ g/mol) of polyolefin,
D: gas permeability (×10⁻⁵ Darcy) of the microporous membrane,
d: average pore size (nm) of the microporous membrane, and
ε: porosity of the microporous membrane.
   9. Break-Down Voltage (kV/μm)

The BDV of the microporous membrane was measured in accordance with ASTM D149, and evaluated as a voltage (kV) when a leakage current value was 5 mA which was measured under the conditions of placing the separator between electrodes of a withstand voltage tester (Croma, model 19052) under a dry room (dew point temperature: −60° C.) and then raising an applied voltage to 5 kV/0 sec.

The total average thickness (t, μm) of the microporous membrane was obtained by overlapping the microporous membrane in 8 layers, measuring each thickness at 5 random points in the TD direction by a thickness meter available from Mitutoyo, dividing the value by 5 to derive an average thickness of the 8-layer microporous membrane, and dividing the value by 8 again to derive a total average thickness of a single microporous membrane.

To compare the calculated BDV with the thickness, a BDV/t value, which is a ratio of the calculated BDV to the total average thickness (t) of the microporous membrane, was calculated.

### 10. Hot-Box Evaluation

A hot-box evaluation was performed using a battery assembled as follows, to which the microporous membrane was used as a separator.

Manufacture of positive electrode: 92 wt % of a lithium cobalt composite oxide (LiCoO₂) as a positive electrode active material, 4 wt % of carbon black as a conductive material, and 4 wt % of polyvinylidene fluoride (PVdF) as a binder were added to N-methyl-2-pyrrolidone (NMP) as a solvent to prepare a positive electrode mixture slurry. The prepared slurry was applied on an aluminum (Al) thin film having a thickness of 30 μm and dried at a temperature of 120° C., and roll-pressing was performed to manufacture a positive electrode having a thickness of 140 μm.

Manufacture of negative electrode: 96 wt % of graphite carbon, 3 wt % of PVdF as a binder, and 1 wt % of carbon black as a conductive material were added to NMP as a solvent to prepare a negative electrode mixture slurry. The prepared slurry was applied on a copper (Cu) thin film having a thickness of 20 μm, dried at 120° C., and roll-pressed to manufacture a negative electrode having a thickness of 150 μm.

A pouch type battery was assembled by stacking the manufactured separator between the positive electrode and the negative electrode, and an electrolyte solution of ethylene carbonate (EC)/ethyl methyl carbonate (EMC)/dimethyl carbonate (DMC)=3:5:2 (volume ratio) in which 1M lithium hexafluorophosphate (LiPF₆) was dissolved and injected into each assembled battery to manufacture a lithium secondary battery. Thus, a pouch type lithium secondary battery having a capacity of 2 Ah was manufactured.

The assembled battery was subjected to aging and degassing operations, fully charged to 4.2 V, put into an oven, heated in 5° C. increments to reach 130° C., and allowed to stand for 30 minutes, thereby measuring a battery change. After allowing the battery to stand at 130° C. for 30 minutes, when fuming or ignition occurred in the battery, it was determined as “Fail”, and when no change in voltage/current of the battery and fuming and ignition did not occur, it was determined as “Pass”.

### 11. Overcharge Evaluation

In the overcharge evaluation, safety against overcharging was confirmed in an insulated chamber by (1) applying a current of 200 mA to the battery manufactured in 10. Hot-box evaluation above to charge the battery to 4.2 V, (2) discharging the battery at a current of 200 mA to 3V to charge/discharge the battery in one cycle, (3) applying a constant current of 1000 mA to charge the battery to 4.2 V, (4) maintaining the voltage constant to allow the battery to stand until the charging current was 30 mA or less, (5) raising the voltage to 5.0 V at 1000 mA, and (6) observing the appearance of the battery and battery temperature change while maintaining the voltage for 2 hours. When fuming/ignition occurred, it was determined as “Fail”, and when no fuming/ignition occurred, it was determined as “Pass”.

### 12. Initial Resistance Evaluation

The initial resistance evaluation was performed using the battery manufactured in 10. Hot-box evaluation. When the initial resistance was 54 mΩ or less, the capacity was maintained at 50% or more in a 2C-rate discharge test, and thus, the initial resistance value was an evaluation indicator for battery output characteristics.

### Example 1 Manufacture of Polyolefin-Based Microporous Membrane

30 wt % of polyethylene (viscosity average molecular weight: 6×10⁵ g/mol) and 70 wt % of a diluent were melted and kneaded through an extruder to prepare a molten material which was a thermodynamically single phase, and then the molten material was molded into a sheet form using a cooling roll. Next, the sheet was stretched 9 folds in the MD at 90° C., stretched 11 folds in the TD in the pre-heating (PH; applying heat without stretching)-stretching (ST; applying heat to perform stretching)-heat-setting (HS; applying only heat to the stretched sheet without stretching/relaxation) at 117° C., 120° C., and 124° C., respectively, extracting the diluent, and transferring the sheet to a drying roll to dry the sheet. The dried sheet was stretched (1.55 folds) at 134° C.-heat fixation-relaxed (0.87 folds) to manufacture a polyolefin-based microporous membrane having a thickness of 9.4 μm.

### Examples 2 TO 4

Polyolefin microporous membranes were manufactured in the same manner as in Example 1, referring to the following Table 1:

### Comparative Examples 1 to 7

Polyolefin microporous membranes were manufactured in the same manner as in Example 1, referring to the following Table 2:

TABLE 1

| Example | 1 | 2 | 3 | 4 |
|---|---|---|---|---|
| PO Mv (×10⁵ g/mol) | 6 | 10 | 20 | 15 |
| PO content (wt %) | 30 | 25 | 17 | 19 |
| Diluent content (wt %) | 70 | 75 | 83 | 81 |
| MD stretching temperature (° C.) | 90 | 85 | 80 | 80 |
| MD stretching ratio | 9.0 | 8.0 | 8.5 | 9.5 |
| TD stretching temperature | 117/120/124 | 118/122/126 | 122/125/129 | 123/126/130 |
| (PH/ST/HS, ° C.) | | | | |
| TD stretching ratio | 11.0 | 9.0 | 10.0 | 12.0 |
| MD/TD stretching ratio | 0.82 | 0.89 | 0.85 | 0.79 |
| Heat fixation temperature (° C.) | 134.0 | 135.5 | 137.0 | 137.5 |
| Heat fixation stretching ratio | 1.55 | 1.50 | 1.50 | 1.50 |
| Heat fixation relaxation ratio | 0.87 | 0.86 | 0.90 | 0.86 |

TABLE 2

| Comparative Example | 1 | 2 | 3 | 4 | 5 | 6 | 7 |
|---|---|---|---|---|---|---|---|
| PO Mv (×105 | 3 | 6 | 10 | 6 | 20 | 10 | 15 |
| g/mol) | | | | | | | |
| PO content | 30 | 30 | 25 | 30 | 17 | 25 | 19 |
| (wt %) | | | | | | | |
| Diluent content | 70 | 70 | 75 | 70 | 83 | 75 | 81 |
| (wt %) | | | | | | | |
| MD stretching | 100 | 90 | 110 | 100 | 80 | 100 | 85 |
| temperature | | | | | | | |
| (° C.) | | | | | | | |
| MD stretching | 10.0 | 10.0 | 10.0 | 9.0 | 9.5 | 8.0 | 10.0 |
| ratio | | | | | | | |
| TD stretching | 120/ | 121/ | 124/ | 119/ | 126/ | 120/ | 125/ |
| temperature | 123/126 | 121/121 | 124/124 | 122/125 | 126/126 | 124/128 | 125/125 |
| (PH/ST/HS, ° C.) | | | | | | | |
| TD stretching | 10.0 | 9.0 | 8.0 | 11.0 | 10.0 | 10.0 | 10.0 |
| ratio | | | | | | | |
| MD/TD | 1.0 | 1.1 | 1.25 | 0.82 | 0.95 | 0.8 | 1.0 |
| stretching ratio | | | | | | | |
| Heat fixation | 133 | 132 | 136 | 135 | 139 | 136.5 | 137 |
| temperature | | | | | | | |
| (° C.) | | | | | | | |
| Heat fixation | 1.5 | 1.5 | 1.6 | 1.2 | 1.5 | 1.5 | 1.5 |
| stretching ratio | | | | | | | |
| Heat fixation | 0.93 | 0.90 | 0.86 | 0.91 | 0.93 | 0.86 | 0.86 |
| relaxation ratio | | | | | | | |

The polyolefin microporous membranes according to the examples and the comparative examples and the batteries manufactured using the polyolefin-based microporous membranes were evaluated according to the above test methods, and the results are shown in the following Tables 3 to 6:

TABLE 3

| Example | 1 | 2 | 3 | 4 |
|---|---|---|---|---|
| Thickness (μm) | 9.4 | 10.1 | 7.8 | 9.1 |
| Puncture strength (N/μm) | 0.54 | 0.56 | 0.60 | 0.67 |
| Gas permeability | 3.1 | 3.2 | 3.2 | 3.4 |
| (×10⁻⁵ Darcy) | | | | |
| Porosity | 0.39 | 0.40 | 0.42 | 0.43 |
| Average pore size (nm) | 38.5 | 39.8 | 37.6 | 40.5 |
| Shrinkage rate at 120° C. for | 7.5/4.5 | 5.1/4.7 | 6.2/8.8 | 6.3/9.0 |
| 1 hr (MD/TD, %) | | | | |
| BDV index | 15.6 | 16.4 | 19.4 | 17.0 |
| BDV (kV/μm) | 0.136 | 0.151 | 0.164 | 0.155 |

TABLE 4

| Comparative Example | 1 | 2 | 3 | 4 | 5 | 6 | 7 |
|---|---|---|---|---|---|---|---|
| Thickness | 11.2 | 11.7 | 9.5 | 8.9 | 8.3 | 8.7 | 10.5 |
| (μm) | | | | | | | |
| Puncture strength | 0.37 | 0.31 | 0.58 | 0.57 | 0.58 | 0.54 | 0.64 |
| (N/μm) | | | | | | | |
| Gas permeability | 3.2 | 4.0 | 2.3 | 2.4 | 4.0 | 2.2 | 3.3 |
| (×10⁻⁵ Darcy) | | | | | | | |
| Porosity | 0.47 | 0.44 | 0.35 | 0.37 | 0.48 | 0.36 | 0.42 |
| Average pore size | 35.5 | 44.1 | 42.8 | 35.1 | 38.9 | 44.3 | 41.2 |
| (nm) | | | | | | | |
| Shrinkage rate at | 9.0/11.7 | 7.5/12.3 | 5.6/11.9 | 6.5/10.9 | 6.2/20.0 | 4.2/3.2 | 7.1/13.5 |
| 120° C. for 1 hr | | | | | | | |
| (MD/TD, %) | | | | | | | |
| BDV index | 11.1 | 9.5 | 19.5 | 21.2 | 14.1 | 23.6 | 17.3 |
| BDV (kV/μm) | 0.115 | 0.109 | 0.149 | 0.149 | 0.128 | 0.178 | 0.159 |

TABLE 5

| Example | 1 | 2 | 3 | 4 |
|---|---|---|---|---|
| Initial resistance (mΩ) | 53 | 51 | 51 | 49 |
| Overcharge evaluation | Pass | Pass | Pass | Pass |
| Hot-box evaluation | Pass | Pass | Pass | Pass |

TABLE 6

| Comparative Example | 1 | 2 | 3 | 4 | 5 | 6 | 7 |
|---|---|---|---|---|---|---|---|
| Initial resistance | 51 | 40 | 64 | 62 | 40 | 64 | 50 |
| (mΩ) | | | | | | | |
| Overcharge | Fail | Fail | Pass | Pass | Fail | Pass | Pass |
| evaluation | | | | | | | |
| Hot-box | Fail | Fail | Fail | Fail | Fail | Pass | Fail |
| evaluation | | | | | | | |

As confirmed from Tables 3 to 6, the secondary batteries incorporating the polyolefin-based microporous membranes according to the examples which satisfied the gas permeability of 2.5×10⁻⁵ Darcy or more, the shrinkage rate in the TD at 120° C. of 10% or less, and the BDV index of 15 or more simultaneously all had a low initial resistance of 54 mΩ or less and thus, had excellent charge/discharge characteristics, and had better insulation properties and better safety at high voltage and/or high temperature than the secondary batteries incorporating the polyolefin-based microporous membranes according to the comparative examples.

A polyolefin-based microporous membrane having agas permeability of 2.5×10⁻⁵ Darcy or more, a shrinkage rate in the TD at 120° C. of 10% or less, and a BDV index of 15 or more result in improved strength and permeability and insulation properties of the polyolefin-based microporous membrane, thereby improving battery stability.

The above description is only an example to which the principle of the present disclosure is applied, and other constitutions may be further included without departing from the scope of the present disclosure. Hereinabove, though an implementation has been described in detail by the examples and the experimental examples, the scope of an implementation is not limited to specific examples and should be construed by the appended claims.

What is claimed is:

1. A polyolefin-based microporous membrane comprising a polyolefin-based resin, wherein the polyolefin-based microporous membrane has a gas permeability of about 2.5×10⁻⁵ Darcy or more, a shrinkage rate in the transverse direction (TD) at 120° C. of about 10% or less, and a BDV index of about 15 or more as represented by the following Equation 1:
$$BDV index = ( \frac{( {P}^{2} + \sqrt[4]{M} )}{D \times \sqrt{d} \times \sqrt{ε}} ) \times 100 \qquad [ Equation 1 ]$$
wherein:
P: puncture strength (N/μm) of the polyolefin-based microporous membrane,
M: viscosity average molecular weight (×10⁵ g/mol) of polyolefin,
D: gas permeability (×10⁻⁵ Darcy) of the polyolefin-based microporous membrane,
d: average pore size (nm) of the polyolefin-based microporous membrane, and
ε: porosity of the polyolefin-based microporous membrane.

2. The polyolefin-based microporous membrane of claim 1, wherein the polyolefin-based resin has a viscosity average molecular weight of about 3×10⁵ g/mol to about 50×10⁵ g/mol.

3. The polyolefin-based microporous membrane of claim 1, wherein the polyolefin-based microporous membrane has a break-down voltage (BDV) to average thickness of about 0.13 kV/μm or more, wherein the BDV is measured in accordance with ASTM D149.

4. The polyolefin-based microporous membrane of claim 1, wherein the polyolefin-based microporous membrane has a puncture strength of about 0.4 N/μm or more.

5. The polyolefin-based microporous membrane of claim 1, wherein the porosity of the polyolefin-based microporous membrane is calculated by the following Equation 2:
$$Porosity = \{ 1 - ( M \times 10000 ) / ( ABT ρ ) \} , \qquad [ Equation 2 ]$$
wherein:
M is mass (in g) of the polyolefin-based microporous membrane after cutting it into a rectangular shape of length A (in cm)×width B (in cm);
T is thickness in μm; and
ρ is density (in g/cm³).

6. The polyolefin-based microporous membrane of claim 5, wherein the polyolefin-based microporous membrane has a porosity of about 0.2 or more.

7. The polyolefin-based microporous membrane of claim 1, wherein the polyolefin-based microporous membrane has a thickness of about 3 μm to about 20 μm.

8. The polyolefin-based microporous membrane of claim 1, wherein the polyolefin-based microporous membrane has an average pore size of about 10 nm to about 100 nm as measured in accordance with ASTM F316-03.

9. The polyolefin-based microporous membrane of claim 1, wherein a shrinkage rate in the machine direction (MD) at 120° C. is 10% or less.

10. A method for manufacturing a polyolefin-based microporous membrane, the method comprising:
kneading a polyolefin-based resin and a diluent to prepare a molten material;
molding the molten material into a sheet form to make a molded sheet;
stretching the molded sheet; and
extracting the diluent,
wherein the polyolefin-based microporous membrane has a gas permeability of about 2.5×10⁻⁵ Darcy or more, a shrinkage rate in the transverse direction (TD) at 120° C. of about 10% or less, and a BDV index of about 15 or more as represented by the following Equation 1:
$$BDV index = ( \frac{( {P}^{2} + \sqrt[4]{M} )}{D \times \sqrt{d} \times \sqrt{ε}} ) \times 100 \qquad [ Equation 1 ]$$
wherein each variable is defined as follows:
P: puncture strength (N/μm) of the polyolefin-based microporous membrane,
M: viscosity average molecular weight (×10⁵ g/mol) of polyolefin,
D: gas permeability (×10⁻⁵ Darcy) of the polyolefin-based microporous membrane,
d: average pore size (nm) of the polyolefin-based microporous membrane, and
ε: porosity of the polyolefin-based microporous membrane.

11. The method for manufacturing a polyolefin-based microporous membrane of claim 10, wherein the stretching of the molded sheet comprises stretching the molded sheet in the MD to a length about 6-fold to about 15-fold longer than its original MD length at a temperature of about 60° C. to about 130° C. to make a MD-stretched molded sheet.

12. The method for manufacturing a polyolefin-based microporous membrane of claim 11, wherein the stretching of the molded sheet further includes stretching the MD-stretched molded sheet in the TD to a length about 6-fold to about 15-fold longer than its original TD length at a temperature of about 80° C. to about 130° C.

13. The method for manufacturing a polyolefin-based microporous membrane of claim 12, wherein the ratio of length stretched in the MD direction to length stretched in the TD direction is less than 1.0.

14. The method for manufacturing a polyolefin-based microporous membrane of claim 10, further comprising drying after extracting of the diluent.

15. The method for manufacturing a polyolefin-based microporous membrane of claim 10, further comprising heat fixing at a temperature of 100° C. to 150° C. after extracting of the diluent.

16. The method for manufacturing a polyolefin-based microporous membrane of claim 10, wherein the polyolefin-based microporous membrane is a separator.

17. A separator comprising a polyolefin-based microporous membrane, wherein the polyolefin-based microporous membrane includes a polyolefin, and has a gas permeability of about 2.5×10⁻⁵ Darcy or more, a shrinkage rate in the transverse direction (TD) at 120° C. of about 10% or less, and a BDV index of about 15 or more as represented by the following Equation 1:
$$BDV index = ( \frac{( {P}^{2} + \sqrt[4]{M} )}{D \times \sqrt{d} \times \sqrt{ε}} ) \times 100 \qquad [ Equation 1 ]$$
wherein each variable is defined as follows:
P: puncture strength (N/μm) of the polyolefin-based microporous membrane,
M: viscosity average molecular weight (×10⁵ g/mol) of polyolefin,
D: gas permeability (×10⁻⁵ Darcy) of the polyolefin-based microporous membrane,
d: average pore size (nm) of the polyolefin-based microporous membrane, and
ε: porosity of the polyolefin-based microporous membrane.

18. A secondary battery comprising the separator of claim 17.
